(19) United States
(12) Patent Application Publication
(10) Pub. No.: US 2026/0089455 A1
(43) Pub. Date: Mar. 26, 2026

(54) APPARATUS, METHOD, COMPUTER PROGRAM FOR ENCODING MULTI-MICROPHONE AUDIO AS METADATA ASSISTED SPATIAL AUDIO

(71) Applicant: Nokia Technologies Oy, Espoo (FI)

(72) Inventors: Lasse Juhani LAAKSONEN, Tampere (FI); Miikka Tapani VILERMO, Tampere (FI); Arto Juhani LEHTINIEMI, Tampere (FI)

(21) Appl. No.: 19/214,247

(22) Filed: May 21, 2025

(30) Foreign Application Priority Data
Jun. 4, 2024 (GB) 2407909.7

(51) Int. Cl. H04S 7/00; G10L 19/008

(52) U.S. Cl. CPC H04S 7/30; G10L 19/008

(57) ABSTRACT

An apparatus comprising means for:
obtaining image-based sound source location data from image analysis of one or more captured images;
encoding multi-microphone audio as metadata assisted spatial audio comprising spatial audio metadata parameters;
encoding the image-based sound source location data within one or more spatial audio metadata parameters of the metadata assisted spatial audio, wherein the one or more spatial audio metadata parameters encoding the image-based sound source location data is or are one or more spatial audio metadata parameters defining a spatial distribution of audio energy.

An apparatus, method, computer program for encoding multi-microphone audio as metadata assisted spatial audio.

### TECHNOLOGICAL FIELD

Examples of the disclosure relate to an apparatus, method, computer program for encoding multi-microphone audio as metadata assisted spatial audio.

### BACKGROUND

The metadata assisted spatial audio (MASA) format is a parametric spatial audio format consisting of audio signals and metadata.

The metadata includes spatial metadata parameters providing information about the captured spatial audio scene for transmission and reproduction of the spatial audio, and descriptive metadata parameters providing further description about the capture configuration and source format of the spatial audio content represented by the MASA format.

The spatial metadata parameters can include at least one of: direction index, direct-to-total energy ratio, diffuse-to-total energy ratio, remainder-to-total energy ratio, spread coherence, and surround coherence.

The MASA format is supported by the Third Generation partnership (3GPP) Immersive Voice and Audio Service (IVAS) specification.

It would be desirable to improve the use/encoding of the metadata assisted spatial audio (MASA) and, in particular, the use of spatial metadata parameters.

### BRIEF SUMMARY

According to various, but not necessarily all, examples there is provided an apparatus comprising means for:
obtaining image-based sound source location data from image analysis of one or more captured images;
encoding multi-microphone audio as metadata assisted spatial audio comprising spatial audio metadata parameters;
encoding the image-based sound source location data within one or more spatial audio metadata parameters of the metadata assisted spatial audio, wherein the one or more spatial audio metadata parameters encoding the image-based sound source location data is or are one or more spatial audio metadata parameters defining a spatial distribution of audio energy.

In some, but not necessarily all examples, the means for encoding the image-based sound source location data within one or more spatial audio metadata parameters of the metadata assisted spatial audio is configured to: vary the one or more spatial audio metadata parameters, that are a result of encoding the multi-microphone audio as metadata assisted spatial audio, in dependence upon the image-based sound source location data.

In some, but not necessarily all examples, the one or more spatial audio metadata parameters encoding the image-based sound source location data comprise at least one direction index dependent upon the image-based sound source location data.

In some, but not necessarily all examples, the one or more spatial audio metadata parameters encoding the image-based sound source location data comprise at least one coherence parameter dependent upon the image-based sound source location data.

In some, but not necessarily all examples, the one or more spatial audio metadata parameters encoding the image-based sound source location data comprise at least one spread coherence parameter dependent upon the image-based sound source location data, wherein the spread coherence parameter defines coherence of a directional sound.

In some, but not necessarily all examples, the at least one spread coherence parameter is varied in dependence upon the image-based sound source location data, to include a location of the image-based sound source within an increased spatial distribution of audio energy defined by the varied spread coherence parameter.

In some, but not necessarily all examples, the at least one spread coherence parameter is varied dependent upon a history of image-based sound source location data, to include a range of probable locations of the image-based sound source within a spatial distribution of audio energy defined by the varied spread coherence parameter.

In some, but not necessarily all examples, the one or more spatial audio metadata parameters encoding the image-based sound source location data comprise at least one surround coherence parameter dependent upon the image-based sound source location data, wherein the whether surround coherence parameter defines coherence of non-directional sound.

In some, but not necessarily all examples, the image-based sound source location data is indicative of one or more of: a width of a sound source, a size of a sound source, a direction to a sound source.

In some, but not necessarily all examples, the apparatus comprises means for performing the image analysis, comprising means for processing one or more captured images to generate the image-based sound source location data, wherein the image-based sound source location data defines at least a location for a sound source.

In some, but not necessarily all examples, the apparatus comprises means for performing the image analysis, comprising means for processing one or more captured images to generate the image-based sound source location data, wherein the image-based sound source location data defines at least a spatial distribution of a sound source.

In some, but not necessarily all examples, the apparatus comprises means for performing the image analysis, comprising means for processing one or more captured images to generate the image-based sound source location data, wherein the image-based sound source location data defines at least a shape and/or a size of a sound source.

In some, but not necessarily all examples, the apparatus comprises means for performing the image analysis, comprising means for processing one or more captured images to generate the image-based sound source location data for a sound source determined as a probable source of captured multi-microphone audio.

In some, but not necessarily all examples, the apparatus comprises means for performing the image analysis, comprising means for processing one or more captured images to generate the image-based sound source location data, wherein the processing of the one or more captured images is constrained to a direction of a probable source of captured multi-microphone audio.

In some, but not necessarily all examples, the one or more captured images differ by time of capture and/or by field of view of capture.

In some, but not necessarily all examples, the apparatus comprises means for converting the one or more captured images to time-frequency tiles for image analysis.

In some, but not necessarily all examples, the apparatus comprises means for processing the one or more captured images using a trained machine learning algorithm that uses synchronization of visual and audio modalities to jointly parse sounds and images, and associate parsed image regions with parsed sounds.

In some, but not necessarily all examples, the apparatus comprises multiple microphones configured to capture the multi-microphone audio.

In some, but not necessarily all examples, the apparatus comprises one or more cameras configured to obtaining capture one or more images to be analyzed to obtain the image-based sound source location data.

In some, but not necessarily all examples, the apparatus is configured as a body-portable apparatus.

According to various, but not necessarily all, examples there is provided a method comprising:
obtaining image-based sound source location data from image analysis of one or more captured images;
encoding multi-microphone audio as metadata assisted spatial audio comprising spatial audio metadata parameters;
encoding the image-based sound source location data within one or more spatial audio metadata parameters of the metadata assisted spatial audio,
wherein the one or more spatial audio metadata parameters encoding the image-based sound source location data is or are one or more spatial audio metadata parameters defining a spatial distribution of audio energy.

According to various, but not necessarily all, examples there is provided a computer program that when run by one or more processors of an apparatus, causes the apparatus to:
obtain image-based sound source location data from image analysis of one or more captured images;
encode multi-microphone audio as metadata assisted spatial audio comprising spatial audio metadata parameters;
encode the image-based sound source location data within one or more spatial audio metadata parameters of the metadata assisted spatial audio, wherein the one or more spatial audio metadata parameters encoding the image-based sound source location data is or are one or more spatial audio metadata parameters defining a spatial distribution of audio energy.

According to various, but not necessarily all, embodiments there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all the features described in respect of other examples of the disclosure, and vice versa. Also, it is to be appreciated that any one or more or all the features, in any combination, may be implemented by/comprised in/performable by an apparatus, a method, and/or computer program instructions as desired, and as appropriate. The description of a function should additionally be considered to also disclose any means suitable for performing that function

### BRIEF DESCRIPTION

Some examples will now be described with reference to the accompanying drawings in which:

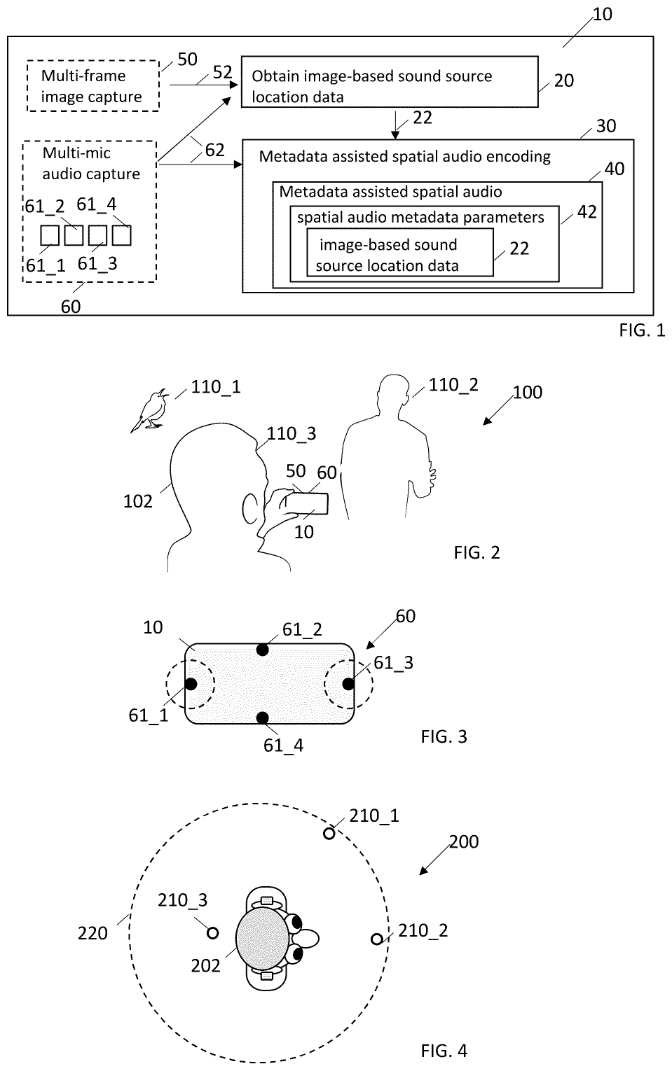

FIG. 1 illustrates an example of an apparatus 10 for encoding image-based sound source location data 22 within one or more spatial audio metadata parameters 42 of metadata assisted spatial audio 40;

FIG. 2 illustrates an example of an audio scene 100 that is being captured by the apparatus 10 under control of a user 102;

FIG. 3 illustrates an example of the apparatus 10, for example as used in FIG. 2;

FIG. 4 illustrates rendering of the audio scene 100 captured in FIG. 2 as a rendered audio scene 200;

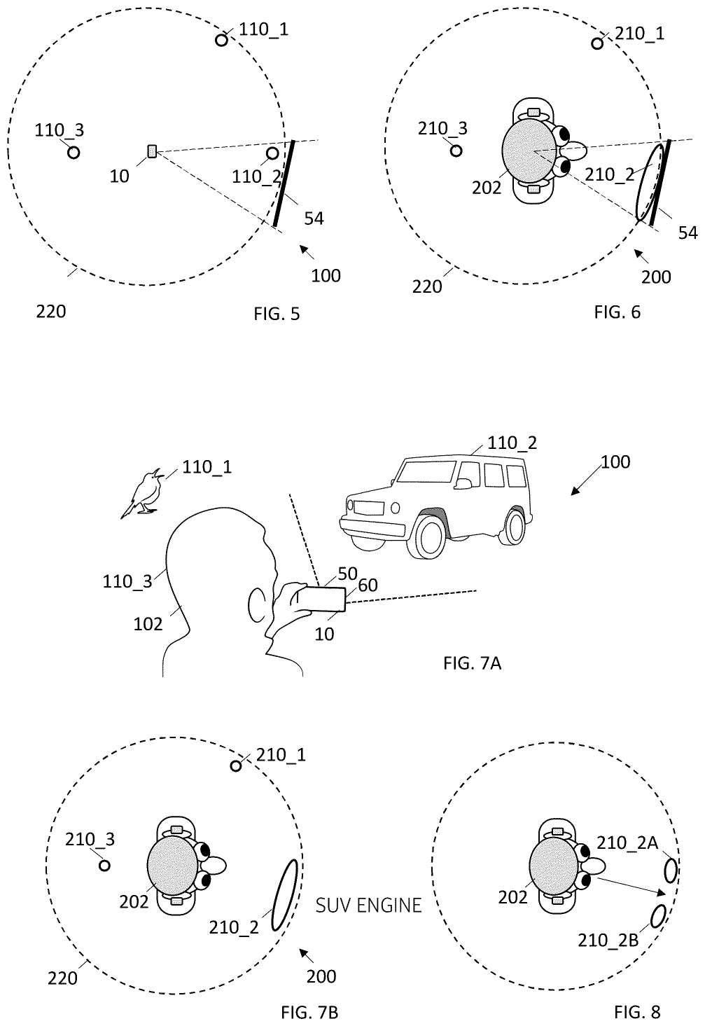

FIG. 5 illustrates an example of an audio scene 100 that is being captured by the apparatus 10 under control of a user 102;

FIG. 6 illustrates an example of rendering of the audio scene 100 captured in FIG. 5 as a rendered audio scene 200;

FIG. 7A illustrates an example of an audio scene 100 that is being captured by the apparatus 10 under control of a user 102;

FIG. 7B illustrates rendering of the audio scene 100 captured in FIG. 7A as a rendered audio scene 200;

FIG. 8 illustrates another example of rendering of the audio scene 100 captured in FIG. 7A as a rendered audio scene 200;

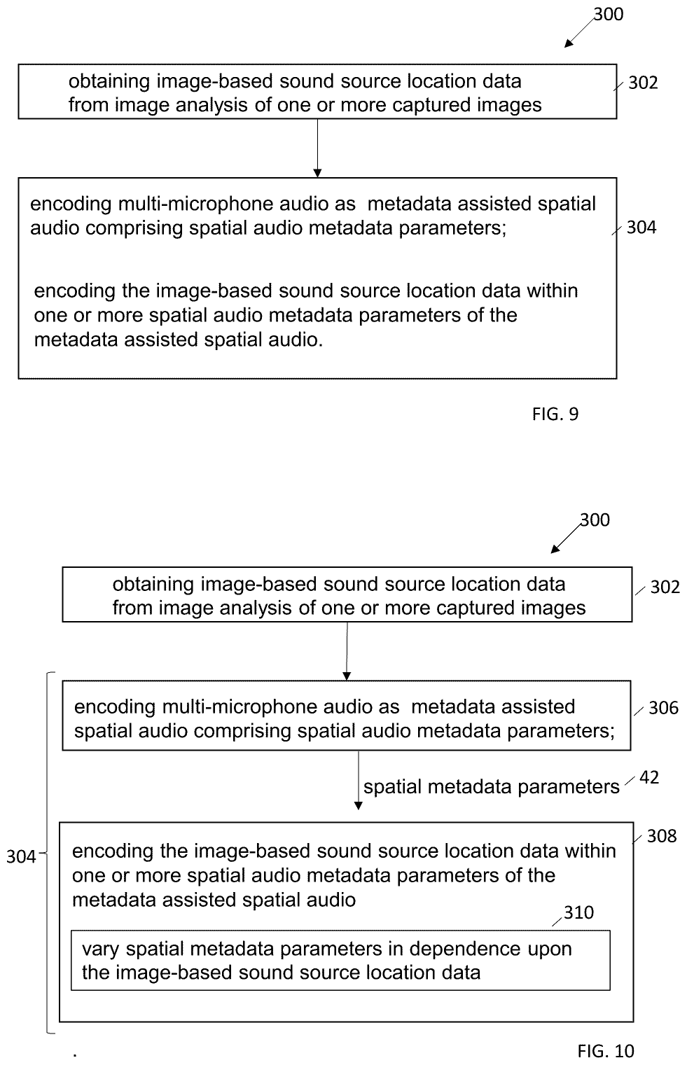

FIG. 9 illustrates a method 300 for encoding image-based sound source location data 22 within one or more spatial audio metadata parameters 42 of metadata assisted spatial audio 40;

FIG. 10 illustrates an example of the method 300 previously described with reference to FIG. 9, in which encoding multi-microphone audio 62 as metadata assisted spatial audio 40 comprising spatial audio metadata parameters 42 precedes encoding the image-based sound source location data 22 within one or more spatial audio metadata parameters 42 of the metadata assisted spatial audio 40;

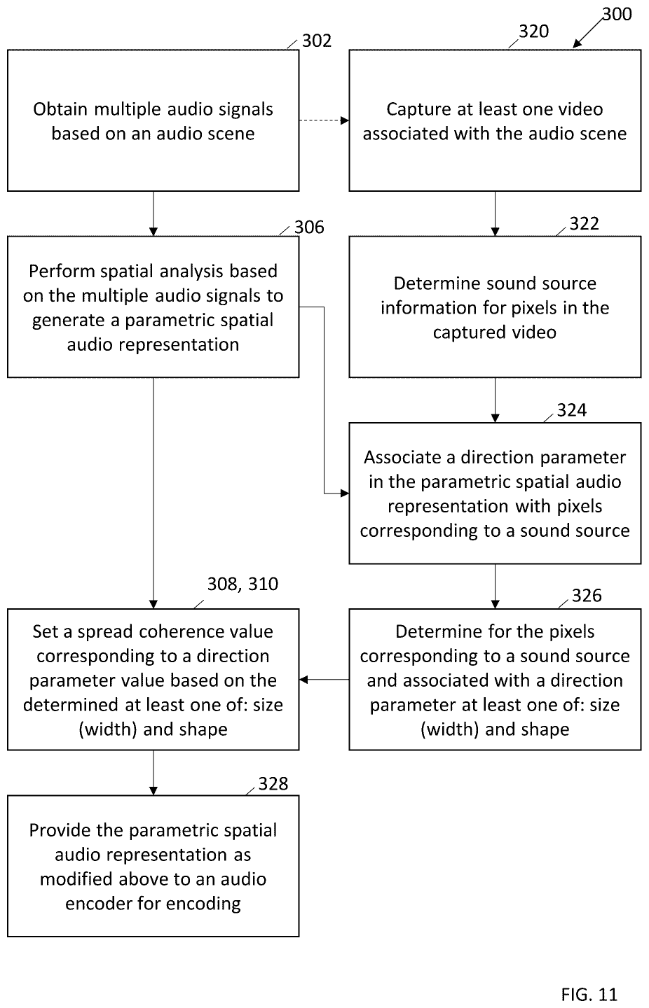

FIG. 11 illustrates a more detailed example of the method 300 illustrated in FIG. 10;

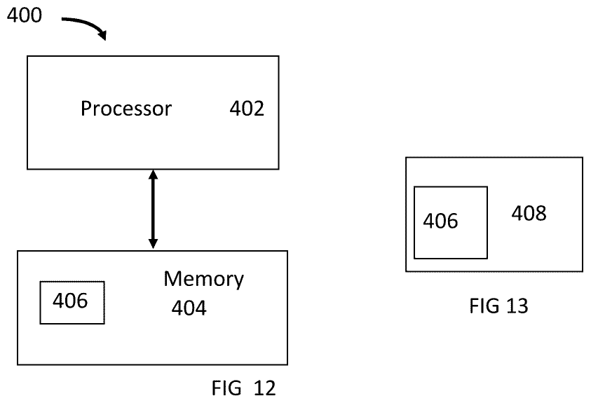

FIG. 12 illustrates a controller 400 suitable for use in the apparatus 10;

FIG. 13 illustrates a computer program 406 suitable for use in the apparatus 10 or controller 400.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

In the following description a class (or set) can be referenced using a reference number without a subscript index (e.g. 110, 210) and a specific instance of the class (member of the set) can be referenced using the reference number with a numerical type subscript index (e.g. 110_1) and a non-specific instance of the class (member of the set) can be referenced using the reference number with a variable type subscript index (e.g. 110_i).

### DETAILED DESCRIPTION

FIG. 1 illustrates an example of an apparatus 10 comprising:
means 20 for obtaining image-based sound source location data 22 from image analysis of one or more captured images 52; and means 30 for
encoding multi-microphone audio 62 as metadata assisted spatial audio 40 comprising spatial audio metadata parameters 42; and
encoding the image-based sound source location data 22 within one or more spatial audio metadata parameters 42 of the metadata assisted spatial audio 40.

The spatial audio captured from a sound source (the spatial audio metadata parameters 42 of the metadata assisted spatial audio 40) will vary if the captured images 52 of the sound source varies.

The image-based sound source location data 22 can be any suitable data that locates an image-based sound source. For example, data that locates a sound source of the multi-microphone audio that corresponds to a source, in one or more captured images 52, for that multi-microphone audio 62.

The location data can, for example, define one or more directions, one or more locations, directions, a size and/or shape at a direction. The size can be in one dimension (width or height), two dimensions (area), or three dimensions (volume).

The image-based sound source location data 22 can be generated at the apparatus 10 or elsewhere.

In some but not necessarily all examples, the apparatus 10 further comprises means 60 for capturing multi-microphone audio 62, for example microphones 61. In the example illustrated, but not necessarily in all examples, the apparatus has microphones 61_i.

In some but not necessarily all examples, the apparatus 10 further comprises means 50 for capturing images 52. The images can be captured over time using multi-frame image capture e.g. video. In the some example, the means 50 for capturing images 52 is one or more cameras, for example, one or more video cameras.

In this example, the apparatus 10 comprises multiple microphones 61_i configured to capture the multi-microphone audio 62 and comprises one or more cameras configured to capture one or more images to be analyzed to obtain the image-based sound source location data 22. In this example, the apparatus 10 is configured as a body-portable apparatus 10. A body-portable apparatus 10 is an apparatus 10 designed to be carried on or by the person, such as a hand-portable apparatus, a head-mounted apparatus, a wearable apparatus etc. In the example illustrated, the apparatus 10 is a hand-portable apparatus configured as a user equipment for a radio telecommunications network.

In some examples, the process of encoding the image-based sound source location data 22 within one or more spatial audio metadata parameters 42 of the metadata assisted spatial audio 40 occurs simultaneously with encoding multi-microphone audio 62 as metadata assisted spatial audio 40 comprising spatial audio metadata parameters 42.

In other examples, the process of encoding multi-microphone audio 62 as metadata assisted spatial audio 40 comprising spatial audio metadata parameters 42 is performed first and the process of encoding the image-based sound source location data 22 within one or more spatial audio metadata parameters 42 of the metadata assisted spatial audio 40 occurs afterwards (post-processing). In some examples, the means 30 for encoding the image-based sound source location data 22 within one or more spatial audio metadata parameters 42 of the metadata assisted spatial audio 40 is configured to vary the one or more spatial metadata parameters, that are a result of encoding the multi-microphone audio 62 as metadata assisted spatial audio 40, in dependence upon the image-based sound source location data 22.

In some but not necessarily all examples, the one or more spatial audio metadata parameters 42 encoding the image-based sound source location data 22 are one or more spatial audio metadata parameters 42 that define a spatial distribution of audio energy.

In some but not necessarily all examples, the one or more spatial audio metadata parameters 42 encoding the image-based sound source location data 22 comprise at least one direction index dependent upon the image-based sound source location data 22.

A direction index can, for example, indicate a direction to a sound source. Multiple direction indices can, for example, indicate directions to a sound source thereby defining a size and/or shape of a sound source.

In some examples, each time-frequency tile can have a direction index and a sound source can be composed of multiple such direction indices.

In some but not necessarily all examples, the one or more spatial audio metadata parameters 42 encoding the image-based sound source location data 22 comprise at least one coherence parameter dependent upon the image-based sound source location data 22. A coherence parameter can, for example, indicate spatial distribution of coherent audio.

In some examples, each time-frequency tile and associated direction index can have a coherence parameter and a sound source can be composed of multiple such direction indices.

In some but not necessarily all examples, the one or more spatial audio metadata parameters 42 encoding the image-based sound source location data 22 comprise at least one spread coherence parameter dependent upon the image-based sound source location data 22. The spread coherence parameter defines coherence of a directional sound. In some but not necessarily all examples, the spread coherence parameter is associated with a direction index of a time-frequency tile of spatial audio. The spread coherence parameter defines a spread of energy for a direction index. It defines whether the direction is to be reproduced as a point source or coherently around the direction. A spread coherent sound refers to directional sound that, instead of being a point source, originates coherently from more than one direction.

In some, but not necessarily all examples, the at least one spread coherence parameter is varied in dependence upon the image-based sound source location data 22, to include a location of the image-based sound source within an increased spatial distribution of audio energy defined by the varied spread coherence parameter. The spread coherence parameter is increased to more widely spread audio energy about the direction defined by the direction index associated with the spread coherence parameter so that is covers the location of the sound source.

In some, but not necessarily all examples, the at least one spread coherence parameter is varied in dependence upon the image-based sound source location data 22, to include a range of probable locations of the image-based sound source within a spatial distribution of audio energy defined by the varied spread coherence parameter. The spread coherence parameter is increased to more widely spread audio energy about the direction defined by the direction index associated with the spread coherence parameter so that is covers the probable locations of the sound source.

The spread coherence parameter can, for example, be increased more if the accuracy of the direction index for a direction of a sound source decreases. This may occur if there is significant re-positioning or re-orientation of the apparatus 10 or if there is obscuring of image capture or audio capture, for example. This spread prevents jitter in the position of a sound source.

In some examples, the direction parameter stability over time and/or frequencies can be compensated using a spread in the direction parameter direction of audio across frequencies to provide further perception of width

In some but not necessarily all examples a spread coherence parameter ζ is varied between 0 and 1, where ζ=0 refers to a point-source, ζ=0.5 refers to three sources at 30 degrees spacing (i.e., spanning 60 degrees in total), and ζ=1 refers to two sources at 60-degree spanning.

In some but not necessarily all examples, the one or more spatial audio metadata parameters 42 encoding the image-based sound source location data 22 comprise at least one surround coherence parameter dependent upon the image-based sound source location data 22, wherein the audio surround coherence parameter defines coherence of non-directional sound.

The surround coherence parameter defines coherence of non-directional, ambient sound. The surround coherence parameter is not associated with a direction index of a time-frequency tile of spatial audio.

In at least some examples, the image-based sound source location data 22 is indicative of one or more of: a width of a sound source, a size of a sound source, a direction to a sound source. In some examples, the image-based sound source location data 22 is indicative of distance to the sound source.

In at least some examples, the means 30 for obtaining image-based sound source location data 22 comprises means for performing image analysis to generate the image-based sound source location data 22. The processing of the one or more captured images 52 generates the image-based sound source location data 22.

In some examples, the processing is such that the image-based sound source location data 22 defines at least a location for a sound source.

In some examples, the processing is such that the image-based sound source location data 22 defines at least a spatial distribution of a sound source.

In some examples, the processing is such that the image-based sound source location data 22 defines at least a shape and/or a size of a sound source.

In some examples, the processing of the one or more captured images 52 generates image-based sound source location data 22 for a sound source determined as a probable source of captured multi-microphone audio 62.

In some examples, the processing of the one or more captured images 52 that generates image-based sound source location data 22, is constrained to a direction of a probable source of captured multi-microphone audio 62.

In some examples, the one or more captured images 52 differ by time of capture. In some examples, the one or more captured images 52 differ by field of view of capture.

In some examples, the one or more captured images 52 differ by time of capture and/or field of view of capture.

The field of view of capture can be different as a consequence of using a single camera with different fields of view e.g. zoom-in, zoom-out or panning.

The field of view of capture can be different as a consequence of using multiple cameras with different fields of view e.g. different orientations or displacements.

In some examples, multiple captured images 52 are captured as video from several different directions relative to the capture point, e.g., a 360-degree camera can be used, or at least two cameras can be used simultaneously (e.g., device main camera and front-facing camera).

In some examples, 3D video (video with parallax) can be used to determine distances of sound sources in addition to their size and shape.

The processing of the one or more captured images 52 can be performed after conversion to sound time-frequency tiles for image analysis.

In some examples, the means for processing the one or more captured images 52 is a trained machine learning algorithm (model) that uses synchronization of visual and audio modalities to jointly parse sounds and images, and associate parsed image regions with parsed sounds.

FIG. 2 illustrates an example of an audio scene 100 that is being captured by the apparatus 10 under control of a user 102.

There are sound sources 110_i in the audio scene 100. The sound sources 110, in this example, include a first sound source 110_1 (a bird), a second sound source 110_2 (a person) and a third sound source 110_3 (a user 102 of the apparatus 10).

The apparatus 10 comprises means 60 for capturing multi-microphone audio 62 of the audio scene 100. For example, multiple microphones 61 can be used for capturing the multi-microphone audio 62 of the audio scene 100.

The apparatus 10 further comprises means 50 for capturing images 52 of the audio scene 100. The captured images 52 can be captured over time using multi-frame image capture e.g. video. In this example the means 50 for capturing images 52 is one or more cameras, for example, one or more video cameras.

FIG. 3 illustrates an example of the apparatus 10, for example as used in FIG. 2. The means 60 for capturing multi-microphone audio 62 of the audio scene 100 comprises multiple spatially distributed microphones 61_1, 61_2, 61_3, 61_4. In this example microphones 61_1, 61_3 are used for capturing multi-microphone audio 62. However, other combinations of two or more microphones are possible.

FIG. 4 illustrates rendering of the audio scene 100 captured in FIG. 2 as a rendered audio scene 200. The rendered audio scene 200 comprises rendered sound sources 210_i.

The rendered sound sources 210_i in the rendered audio scene 200 correspond with respective sound sources 110_i in the captured audio scene 100. The rendered sound sources 210_i include a first rendered sound source 210_1 (a bird), a second rendered sound source 210_2 (a person) and a third rendered sound source 210_3 (a user 102 of the apparatus 10). Diffuse or ambient audio 220 is also rendered.

The first rendered sound source 210_1 (a bird) corresponds to the first captured sound source 110_1 (a bird). The second rendered sound source 210_1 (a person) corresponds to the second captured sound source 110_2 (a person). The third rendered sound source 210_3 (a user 102 of the apparatus 10) corresponds to the third captured sound source 110_3 (a user 102 of the apparatus 10).

The rendered sound sources 210_i are positioned relative to a notional listener 202 in the rendered audio scene. The directions to the rendered sound sources 210_i from the notional listener 202 in the rendered audio scene 200 correspond to the directions to the respective captured sound sources 110_i from the capturing apparatus 10.

In this example, the first rendered sound sources 210_1 (bird) is a point source, the second rendered sound source 210_2 (person) is a point source, and the third rendered sound sources 210_3 (user) is a point source.

In this example, either encoding the image-based sound source location data 22 within one or more spatial audio metadata parameters 42 of the metadata assisted spatial audio 40 is switched off, or it is switched on, and the image-based sound source location data 22 identifies (for example) the captured sound source 110_2 as a point source and therefore renders the captured sound source 110_2, as rendered sound source 210_2, as a point source.

FIGS. 5 and 6 take the example illustrated in FIGS. 2, 3, 4 and demonstrate the effect of encoding the image-based sound source location data 22 within one or more spatial audio metadata parameters 42 of the metadata assisted spatial audio 40.

FIG. 5 illustrates an example of an audio scene 100 that is being captured by the apparatus 10 under control of a user 102. It has been previously described with reference to FIG. 2. The captured images 52 of the audio scene 100 include a portion 54 that corresponds to the second captured sound source 110_2. The portion 54 is captured by one or more cameras.

FIG. 6 illustrates an example of rendering of the audio scene 100 captured in FIG. 5 as a rendered audio scene 200. It has been previously described with reference to FIG. 4.

In this example, the first rendered sound sources 210_1 (bird) is a point source, and the third rendered sound sources 210_3 (user) is a point source. However, the second rendered sound source 210_2 (person) is not a point source, it has an increased extent.

In this example, the image-based sound source location data 22 identifies (for example) that the captured sound source 110_2 has an extension beyond a point source and the rendering apparatus renders the captured sound source 110_2, as rendered sound source 210_2, as an extended sound source 210_2.

The apparatus 10 obtains image-based sound source location data 22 from image analysis of one or more captured images 52 which include an image of the portion 54; encodes the multi-microphone audio 62 as metadata assisted spatial audio 40 comprising spatial audio metadata parameters 42 and encodes the image-based sound source location data 22 within one or more spatial audio metadata parameters 42 of the metadata assisted spatial audio 40. The result is sent, as a bit stream to the rendering apparatus which renders the rendered audio scene 200 illustrated in FIG. 6.

In this example, the one or more spatial audio metadata parameters 42 encoding the image-based sound source location data 22 comprise at least one spread coherence parameter dependent upon the image-based sound source location data 22. The at least one spread coherence parameter is varied in dependence upon the image-based sound source location data 22, to include a location of the image-based sound source within an increased spatial distribution of audio energy defined by the varied spread coherence parameter. The increased spatial distribution of audio energy defined by the varied spread coherence parameter is large enough to cover a portion 54 of the rendered audio scene 200 that corresponds to the portion 54 of the captured audio scene 100.

FIG. 7A illustrates an example of an audio scene 100 that is being captured by the apparatus 10 under control of a user 102.

There are sound sources 110_i in the audio scene 100. The sound sources include a first sound source 110_1 (a bird), a second sound source 110_2 (a car with the engine running) and, optionally, a third sound source 110_3 (a user 102 of the apparatus 10).

The apparatus 10 comprises means 60 for capturing multi-microphone audio 62 of the audio scene 100. For example, multiple microphones can be used for capturing the multi-microphone audio 62 of the audio scene 100.

The apparatus 10 further comprises means 50 for capturing images 52 of the audio scene 100 including an image of the car. The captured images can be captured over time using multi-frame image capture e.g. video. In this example the means 50 for capturing images 52 is one or more cameras, for example, one or more video cameras.

The apparatus 10 obtains image-based sound source location data 22 from image analysis of one or more captured images 52; encodes the multi-microphone audio 62 as metadata assisted spatial audio 40 comprising spatial audio metadata parameters 42 and encodes the image-based sound source location data 22 within one or more spatial audio metadata parameters 42 of the metadata assisted spatial audio 40. The result is sent, as a bit stream to the rendering apparatus which renders the illustrated rendered audio scene in FIG. 6.

In this example, the one or more spatial audio metadata parameters 42 encoding the image-based sound source location data 22 comprise at least one spread coherence parameter dependent upon the image-based sound source location data 22. The at least one spread coherence parameter is varied in dependence upon the image-based sound source location data 22, to include a location of the image-based sound source within an increased spatial distribution of audio energy defined by the varied spread coherence parameter.

The increased spatial distribution of audio energy defined by the varied spread coherence parameter is large enough to cover a portion of the rendered audio scene 200 that corresponds to the portion of the captured audio scene 100 in which the car is located.

FIG. 7B illustrates rendering of the audio scene 100 captured in FIG. 7A as a rendered audio scene 200. The rendered audio scene 200 comprises rendered sound sources 210_i.

The rendered sound sources 210_i in the rendered audio scene 200 correspond with the respective sound sources 110_i in the captured audio scene 100.

The rendered sound sources 210_i include a first rendered sound source 210_1 (a bird), a second rendered sound source 210_2 (a car with the engine running) and, optionally, a third rendered sound source 210_3 (a user 102 of the apparatus 10).

The first rendered sound source 210_1 (a bird) corresponds to the first captured sound source 110_1 (a bird). The second rendered sound source 210_1 (a car) corresponds to the second captured sound source 110_2 (a car). The third rendered sound source 210_3 (a user 102 of the apparatus 10) corresponds to the third captured sound source 110_3 (a user 102 of the apparatus 10).

The rendered sound sources 210_i are positioned relative to a notional listener 202 in the rendered audio scene. The directions to the rendered sound sources 210_i from the notional listener 202 in the rendered audio scene 200 correspond to the directions to the respective captured sound sources 110_i from the capturing apparatus 10.

In this example, the first rendered sound sources 210_1 (bird) is a point source, and the third rendered sound sources 210_3 (user) is a point source. The second rendered sound source 210_2 (car) is an extended sound source.

In some examples, the audio capture can steer a camera selection or camera direction. For example, when a dominant directional sound source is detected in an audio scene 100, the camera best corresponding with this direction can be selected.

FIG. 8 illustrates another example of rendering of the audio scene 100 captured in FIG. 7A as a rendered audio scene 200. The rendered audio scene 200 comprises rendered sound sources 210_2A and 210_2B.

In this example the second rendered sound source 210_2 (car) has been split into two distinct rendered sound sources 210_2A, 210_2B with a gap between them. In this example the two distinct rendered sound sources 210_2A, 210_2B are extended sound sources.

The apparatus 10 obtains image-based sound source location data 22 from image analysis of one or more captured images 52; encodes the multi-microphone audio 62 as metadata assisted spatial audio 40 comprising spatial audio metadata parameters 42 and encodes the image-based sound source location data 22 within one or more spatial audio metadata parameters 42 of the metadata assisted spatial audio 40. The result is sent, as a bit stream to the rendering apparatus which renders the illustrated rendered audio scene in FIG. 8.

In this example, the one or more spatial audio metadata parameters 42 encoding the image-based sound source location data 22 comprise at least one spread coherence parameter dependent upon the image-based sound source location data 22. The at least one spread coherence parameter is varied in dependence upon the image-based sound source location data 22, to split a location of the image-based sound source.

FIG. 9 illustrates a method 300.

Block 302 of the method 300 comprises obtaining image-based sound source location data 22 from image analysis of one or more captured images 52.

### Block 304 of the Method 300 Comprises:

encoding multi-microphone audio 62 as metadata assisted spatial audio 40 comprising spatial audio metadata parameters 42; and
encoding the image-based sound source location data 22 within one or more spatial audio metadata parameters 42 of the metadata assisted spatial audio 40.

FIG. 10 illustrates an example of the method 300 previously described with reference to FIG. 9.

In this example, the process of encoding multi-microphone audio 62 as metadata assisted spatial audio 40 comprising spatial audio metadata parameters 42 is performed first and the process of encoding the image-based sound source location data 22 within one or more spatial audio metadata parameters 42 of the metadata assisted spatial audio 40 occurs afterwards (post-processing). The block 304 is split into sequential blocks 306, 308.

Block 302 of the method 300 comprises obtaining image-based sound source location data 22 from image analysis of one or more captured images 52.

Block 306 of the method 300 comprises encoding multi-microphone audio 62 as metadata assisted spatial audio 40 comprising spatial audio metadata parameters 42.

Block 308 of the method 300 comprises encoding the image-based sound source location data 22 within one or more spatial audio metadata parameters 42 of the metadata assisted spatial audio 40.

At block 308, the method 300 comprises, at block 310, varying the one or more spatial metadata parameters, that are a result of encoding the multi-microphone audio 62 as metadata assisted spatial audio 40 at block 306, in dependence upon the image-based sound source location data 22.

The metadata assisted spatial audio (MASA) format is a parametric spatial audio format, which consists of audio signals and metadata. The MASA format is a parametric spatial audio format that can be used with any multi-microphone array with suitable capture analysis. The MASA format is optimized for immersive audio capture by smartphones and other form factors that may utilize irregular microphone arrays. The MASA format is based on multiple audio channels and an associated set of metadata parameters. At present, the audio signals can be one or two, i.e., mono or stereo. The capture is done in frequency bands with suitable temporal resolution.

The metadata parameters include spatial metadata parameters providing information about the captured spatial audio scene for transmission and reproduction of the spatial audio, and descriptive metadata parameters providing further description about the capture configuration and source format of the spatial audio content represented by the MASA format.

Each MASA metadata frame, corresponding to 20 ms of audio, includes:
the descriptive metadata (consisting of
   a format descriptor and
   a channel audio format field that further defines
      the number of directions described by the spatial metadata, number of audio channels,
   the source format configuration, and
   a variable description depending on the previous information) and
the spatial metadata parameters that are:
   direction index,
   direct-to-total energy ratio,
   diffuse-to-total energy ratio,
   remainder-to-total energy ratio,
   spread coherence, and
   surround coherence.

The direction index (decodable with an elevation and an azimuth component) provides an efficient representation of the multitude of possible spatial directions with about 1-degree accuracy in any arbitrary direction. The direction indices define a spherical grid that covers a sphere with several smaller spheres (defined by the spread coherence) with centres of the spheres giving the points corresponding with the directions.

Each spatial metadata parameter is provided (through capture, analysis, or creation) for each of 96 time-frequency (TF) tiles corresponding to 4 temporal (or time) subframes and 24 frequency bands.

The direct-to-total energy ratio and spread coherence parameters are associated with the direction (parameter). The direction index, direct-to-total energy ratio, and spread coherence parameters are therefore given for each direction described per TF tile (as given by the number of directions descriptive metadata parameter). For each TF tile, the sum of the different energy ratio parameters is 1.0.

During decoding, the MASA spatial metadata parameters (direction, direct-to-total energy ratios associated with the directions, spread coherence, and surrounding coherence) are retrieved from the bitstream for each time-frequency tile of the configured coding time-frequency resolution (1 or 4 temporal subframes and 1-24 coding sub bands) by the MASA metadata decoding.

3GPP Immersive Voice and Audio Services (IVAS) codec supports MASA encoding as an IVAS encoder input format. MASA encoding is also used as part of the OMASA (Objects with MASA) combined format that IVAS encoder supports. 3GPP TS 26.253 provides the detailed algorithmic description of the IVAS codec. The IVAS codec utilizes the MASA model also for channel-based audio encoding at lower bit rates. This operation can be called Multi-channel MASA (McMASA) operation. IVAS provides support of audio formats beyond stereo which include multi-channel audio (5.1, 5.1.2, 5.1.4, 7.1, 7.1.4), scene-based audio (Ambisonics up to 3rd order), metadata-assisted spatial audio (MASA), and object-based audio.

IVAS supports binaural rendering functionality for headphone playback including head-tracking. It operates on 20 ms audio frames and supports multi-rate/multi-mode.

The IVAS encoder analyzes the sound scene, derives spatial audio parameters, and downmixes input channels to so-called transport channels which are processed by the encoding tools.

### MASA Metadata Uses the Following Parameters:

MASA format descriptive common metadata parameters

| Field | Bits | Description |
|---|---|---|
| Format | 64 | Defines the MASA format for IVAS. Eight 8-bit |
| descriptor | | ASCII characters: |
| | | 01001001, 01010110, 01000001, 01010011, |
| | | 01001101, 01000001, 01010011, 01000001 |
| | | Values stored as 8 consecutive 8-bit unsigned |
| | | integers. |
| Channel | 16 | Combined following fields stored in two bytes. |
| audio | | Value stored as a single 16-bit unsigned integer. |
| format | | |
| Number of | (1) | Number of directions described by the spatial |
| directions | | metadata. |
| | | Each direction is associated with a set of direction |
| | | dependent spatial metadata. |
| | | Range of values: [1, 2] |
| Number of | (1) | Number of transport channels in the format. |
| channels | | Range of values: [1, 2] |
| Source | (2) | Describes the original format from which MASA |
| format | | was created. |
| (Variable | (12) | Further description fields based on the values of |
| description) | | ‘Number of channels’ and ‘Source format’ fields. |
| | | When all bits are not used, zero padding is applied. |

MASA format spatial metadata parameters (dependent of number of directions)

| Field | Bits | Description |
|---|---|---|
| Direction | 16 | Direction of arrival of the sound at a |
| index | | time-frequency parameter interval. Spherical |
| | | representation at about 1-degree accuracy. |
| | | Range of values: “covers all directions at |
| | | about 1° accuracy” |
| | | Values stored as 16-bit unsigned integers. |
| Direct-to-total | 8 | Energy ratio for the direction index (i.e., |
| energy ratio | | time-frequency subframe). |
| | | Calculated as energy in direction/total energy. |
| | | Range of values: [0.0, 1.0] |
| | | Values stored as 8-bit unsigned integers with |
| | | uniform spacing of mapped values. |
| Spread | 8 | Spread of energy for the direction index (i.e., |
| coherence | | time-frequency subframe). |
| | | Defines the direction to be reproduced as a point |
| | | source or coherently around the direction. |
| | | Range of values: [0.0, 1.0] |
| | | Values stored as 8-bit unsigned integers with |
| | | uniform spacing of mapped values. |

MASA format spatial metadata parameters (independent of number of directions)

| Field | Bits | Description |
|---|---|---|
| Diffuse-to- | 8 | Energy ratio of non-directional sound over |
| total energy | | surrounding directions. |
| ratio | | Calculated as energy of non-directional sound/total |
| | | energy. |
| | | Range of values: [0.0, 1.0] |
| | | (Parameter is independent of number of directions |
| | | provided.) |
| | | Values stored as 8-bit unsigned integers with |
| | | uniform spacing of mapped values. |
| Surround | 8 | Coherence of the non-directional sound over the |
| coherence | | surrounding directions. |
| | | Range of values: [0.0, 1.0] |
| | | (Parameter is independent of number of directions |
| | | provided.) |
| | | Values stored as 8-bit unsigned integers with |
| | | uniform spacing of mapped values. |
| Remainder- | 8 | Energy ratio of the remainder (such as microphone |
| to-total | | noise) sound energy to fulfil requirement that sum of |
| energy | | energy ratios is 1. |
| ratio | | Calculated as energy of remainder sound/total |
| | | energy. |
| | | Range of values: [0.0, 1.0] |
| | | (Parameter is independent of number of directions |
| | | provided.) |
| | | Values stored as 8-bit unsigned integers with |
| | | uniform spacing of mapped values. |

The MASA format includes certain coherence parameters including spread coherence and surround coherence.

The spread coherence parameter defines the spread of energy for a direction index (i.e., a time-frequency subframe or tile). Spread coherence parameters provides information on how the corresponding direction is to be reproduced as a point source or coherently around that direction. A spread coherent sound refers to directional sound that, instead of being a point source, originates coherently from more than one direction. For example, considering channel-based mixes, an amplitude panned sound would constitute a “spread coherent” sound. In IVAS MASA, spread coherence is expressed by a spread coherence parameter ζ ranging from 0 to 1, where ζ=0 refers to a point-source, ζ=0.5 refers to three sources at 30 degrees spacing (i.e., spanning 60 degrees in total), and ζ=1 refers to two sources at 60-degree spanning.

The “Surround coherence” parameter defines the coherence of the non-directional sound over (all) the surrounding directions.

IVAS MASA metadata is provided once every 20 ms, where each frame includes 4 temporal subframes and 24 frequency bands. The number of directions in each frame can be one or two. Thus, e.g., the spread coherence is provided once or twice for each of the 4×24 time-frequency (TF) tiles.

The IVAS specification describes how spread coherence and surround coherence are calculated for a channel-based input. The corresponding floating-point C code in 3GPP TS26.258 implements this.

There is a spread coherence parameter for each direction in a TF tile, when there is more than one direction present, otherwise there will be a single spread coherence value associated with the TF tile. The encoding of the spread coherence values is performed on a sub band by sub band basis for the spread coherence values associated with the TF tiles of the sub band.

There is a single surround coherence specified for the TF tile which is irrespective of the number of directions.

The coherence parameter sets (spread coherence and surrounding coherence) are inspected separately to deduce if they are significant coherence parameter values present. The presence of spread coherence is checked by inspecting each spread coherence parameter value for each time-frequency tile in each directional parameter set. If any inspected spread coherence parameter value is above a defined threshold, then coherence parameter values are considered to be significantly present. If coherence is present, then output variable for presence of coherence (cohPresent) is set to true. If the previous step for checking spread coherence significance results in coherence not being present, then surrounding coherence is also checked for significance and results in truth value if surrounding coherence is significantly present. This value is assigned to the output variable for presence of coherence (cohPresent).

The coherence parameters in IVAS MASA can be underutilized in current implementations of multi-microphone capture on UEs (e.g., smartphones) in real environments. It may be that spread coherence (and surround coherence) values are simply set to zero, since the capture algorithm cannot reliably determine values that correspond with the real scene. The described encoding of the image-based sound source location data 22 within one or more spatial audio metadata parameters 42 of the metadata assisted spatial audio 40 can therefore utilize an under-utilized resource.

IVAS decoding and rendering convert the IVAS encoded audio signals for reproduction on various playback devices. IVAS binaural rendering generates audio signals for headphones simulating a real-life listening experience. It features binauralization, relying on head-related impulse responses, head-tracking, listener orientation processing and supports room acoustics using binaural room impulse responses or late reverb and spatialized early reflections synthesis.

Various means 20 can be used to obtain image-based sound source location data 22 from image analysis of one or more captured images 52.

In one example, a model is trained to map image features to audio features. The training provides synchronized visual and audio modalities to enable the model to identify visual modalities synchronized with audio modalities. The training can be unsupervised with the model jointly parsing sounds and images, without requiring additional manual supervision. Alternatively, the training can be supervised with training data mapping portions of the video with specific audio. The model can be further extended to map image features mapped to an audio feature to a set of directions.

In one example, a video analysis network is used to extract visual features from video frames and apply a freeform categorization. A ResNet model using temporal pooling and sigmoid activation can be used. An audio analysis network can be used to extract audio features and apply a freeform categorization. The audio can be processed as an audio spectrogram, providing a Time-Frequency (T-F) representation of sound. The output from the video analysis network and the audio analysis network can be combined in a further network that is trained to label audio feature categories with associated visual feature categories (and the directions defining the image category).

The directions defining the portion of the image producing the audio has a direction and a size and shape. Thus, an algorithm can be taught to indicate the shape and size of sound sources in multi-microphone audio from captured images. This process can be automatic, when an apparatus 10 captures video and audio.

FIG. 11 illustrates a more detailed example of the method 300 illustrated in FIG. 10. Block 302 of the method 300 comprises obtaining image-based sound source location data 22 from image analysis of one or more captured images 52.

Simultaneously, at block 320 the method 300 comprises capturing at least one video of the scene associated with the sound sources captured.

Block 306 of the method 300 comprises encoding multi-microphone audio 62 as metadata assisted spatial audio 40 comprising spatial audio metadata parameters 42. This comprises spatial audio capture analysis and generation of the parametric spatial audio representation. It may be that spread coherence (and surround coherence) values are simply set to zero, since the capture algorithm cannot reliably determine values that correspond with the real scene.

At block 322 the method 300 comprises determining sound source information for the features in the captured video.

At block 324 the method 300 comprises associating at least one direction parameter (e.g., from the captured MASA signal) with features (pixels) corresponding to a sound source determined from the video. For example, the apparatus knows which angles the video covers and thus which directions in the spatial audio direction are relevant for the video capture.

At block 326, the apparatus 10 determines at least a size (e.g. width) for the sound source associated with the direction parameter. It could also determine a shape. Block 308 of the method 300 comprises encoding the image-based sound source location data 22 within one or more spatial audio metadata parameters 42 of the metadata assisted spatial audio 40. One or more spatial metadata parameters, that are a result of encoding the multi-microphone audio 62 as metadata assisted spatial audio 40 at block 306, are varied 310 in dependence upon the image-based sound source location data 22.

In this example, the apparatus 10 maps the size (and if available the shape) data to a spread coherence parameter value corresponding to the determined sound source feature (pixel) information.

For example, the apparatus 10 maps the size (and if available the shape) data to a spread coherence value corresponding to the determined sound source feature (pixel) information as follows:
If only size is determined, map to spread coherence values 0<=ζ<=0.5
If also shape is determined, map to spread coherence values 0<=ζ<<=1

At block 328, the apparatus 10 then provides the parametric spatial audio representation, e.g., stereo-MASA, with the updated at least one spread coherence value to an audio encoder, e.g., IVAS encoder, for encoding as an IVAS bitstream. Thus, non-zero spread coherence values are determined for the MASA input format.

The IVAS bitstream is transmitted to an IVAS decoder and renderer. The video captured can be transmitted; however, video transmission is not required.

The method 300 provides video-assisted spatial audio capture for generation of improved metadata parameters for immersive audio encoding, transmission, and decoding/rendering.

The benefit is an improvement in user experience, e.g., more immersive spatial audio reproduction in (head-tracked) binaural rendering or multi-loudspeaker rendering.

The main use case is spatial audio capture for IVAS calls and user-generated content (USG) storage and streaming.

Any inaccuracy of the spatial audio capture could appear as fluctuations of the estimated and reproduced directions over time can be obscured by spreading the rendered sound source. For example, in some case, a sound source could appear moving a little bit even when it remains static in reality but this is hidden if the movement is within the spatial spread of the sound source.

3D video capture can be used to additionally give a reliable distance for the sound source (pixels). For example, early proposals for MASA format included a distance parameter.

Alternatively and in addition, at least the direction parameter in MASA can be modified based on the sound source information determined for the pixels in the video capture. For example, direction parameter stability over time and/or frequencies can be adjusted. Or instead, more variation in direction parameter across frequencies can be introduced to provide further perception of width, e.g., in conjunction with the spread coherence parameter values.

In some embodiments, the video capture can cover several directions relative to the capture point, e.g., a 360-degree camera can be used, at least two cameras can be used simultaneously (e.g., device main camera and front-facing camera).

In further embodiments, the audio capture can steer the camera selection or camera direction. For example, when a dominant directional sound source is detected in a scene, the camera best corresponding with this direction can be selected.

In some embodiments, the video capture device and the audio capture device can be separate devices.

In yet further embodiments, 3D video can be used to determine distance of sound sources in addition to their size and shape.

FIG. 12 illustrates an example of a controller 400 suitable for use in an apparatus 10. Implementation of a controller 400 may be as controller circuitry. The controller 400 may be implemented in hardware alone, have certain aspects in software including firmware alone or can be a combination of hardware and software (including firmware).

As illustrated in FIG. 12 the controller 400 may be implemented using instructions that enable hardware functionality, for example, by using executable instructions 406 in a general-purpose or special-purpose processor 402 that may be stored on a machine-readable storage medium (disk, memory etc.) to be executed by such a processor 402. The processor 402 is configured to read from and write to the memory 404. The processor 402 may also comprise an output interface via which data and/or commands are output by the processor 402 and an input interface via which data and/or commands are input to the processor 402.

The memory 404 stores instructions, program, or code 406 that controls the operation of the apparatus 10 when loaded into the processor 402. The computer program instructions, program or code am 406, provide the logic and routines that enables the apparatus 10 to perform the methods illustrated in the accompanying FIGS. The processor 402 by reading the memory 404 is configured to load and execute the instructions, program, or code 406.

The apparatus 10 comprises:
at least one processor 402; and
at least one memory 404 storing instructions that, when executed by the at least one processor 402, cause the apparatus at least to:
obtain image-based sound source location data 22 from image analysis of one or more captured images 52;
encode multi-microphone audio 62 as metadata assisted spatial audio 40 comprising spatial audio metadata parameters 42;
encode the image-based sound source location data 22 within one or more spatial audio metadata parameters 42 of the metadata assisted spatial audio 40.

As illustrated in FIG. 13, the instructions, program, or code 406 may arrive at the apparatus 10 via any suitable delivery mechanism 408. The delivery mechanism 408 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 406. The delivery mechanism may be a signal configured to reliably transfer the computer program 406. The apparatus 10 may propagate or transmit the computer program 406 as a computer data signal.

The term “non-transitory” as used herein, is a limitation of the medium itself (i.e., tangible, not a signal) as opposed to a limitation on data storage persistency (e.g., RAM vs. ROM). Computer program instructions for causing an apparatus to perform at least the following or for performing at least the following:
obtain image-based sound source location data 22 from image analysis of one or more captured images 52;
encode multi-microphone audio 62 as metadata assisted spatial audio 40 comprising spatial audio metadata parameters 42;
encode the image-based sound source location data 22 within one or more spatial audio metadata parameters 42 of the metadata assisted spatial audio 40.

The computer program instructions may be comprised in a computer program, a non-transitory computer readable medium, a computer program product, a machine readable medium. In some but not necessarily all examples, the computer program instructions may be distributed over more than one computer program.

Although the memory 404 is illustrated as a single component/circuitry it may be implemented as one or more separate components/circuitry some or all of which may be integrated/removable and/or may provide permanent/semi-permanent/dynamic/cached storage.

Although the processor 402 is illustrated as a single component/circuitry it may be implemented as one or more separate components/circuitry some or all of which may be integrated/removable. The processor 402 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all the following:
(a) hardware-only circuitry implementations (such as implementations in only analog and/or digital circuitry) and
(b) combinations of hardware circuits and software, such as (as applicable):
i. a combination of analog and/or digital hardware circuit(s) with software/firmware and
ii. any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the claim element, a baseband integrated circuit for a mobile device or a similar integrated circuit in a server, a cellular network device, or other computing or network device.

The blocks illustrated in the accompanying FIGS. may represent steps in a method and/or sections of code in the computer program 406. The illustration of a particular order to the blocks does not necessarily imply that there is a required or preferred order for the blocks and the order and arrangement of the block may be varied. Furthermore, it may be possible for some blocks to be omitted.

As used here ‘module’ refers to a unit or apparatus that excludes certain parts/components that would be added by an end manufacturer or a user. The apparatus 10 can, for example be a module. A controller 400 of the apparatus 10 can, for example be a module.

Where a structural feature has been described, it may be replaced by means for performing one or more of the functions of the structural feature whether that function or those functions are explicitly or implicitly described.

The above-described examples find application as enabling components of:
automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure.

Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to ‘comprising only one . . . ’ or by using ‘consisting.’

In this description, the wording ‘connect’, ‘couple’ and ‘communication’ and their derivatives mean operationally connected/coupled/in communication. It should be appreciated that any number or combination of intervening components can exist (including no intervening components), i.e., to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database, or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples.

Thus ‘example’, ‘for example’, ‘can’, or ‘may’ refers to a particular instance in a class of examples. A property of the instance can be a property of only that instance or a property of the class or a property of a sub-class of the class that includes some but not all the instances in the class. It is therefore implicitly disclosed that a feature described with reference to one example but not with reference to another example, can where possible be used in that other example as part of a working combination but does not necessarily have to be used in that other example.

As used herein, “at least one of the following:” and “at least one of” and similar wording, where the list of two or more elements are joined by “and” or “or” mean at least any one of the elements, or at least any two or more of the elements, or at least all the elements.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

The description of a feature, such as an apparatus or a component of an apparatus, configured to perform a function, or for performing a function, should additionally be considered to also disclose a method of performing that function. For example, description of an apparatus configured to perform one or more actions, or for performing one or more actions, should additionally be considered to disclose a method of performing those one or more actions with or without the apparatus.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance the Applicant may seek protection via the claims in respect of any patentable feature or combination of features hereinbefore referred to and/or shown in the drawings whether or not emphasis has been placed thereon.

1-22. (canceled)

23. An apparatus comprising:
at least one processor; and
at least one memory storing instructions that, when executed by the at least one processor, cause the apparatus at least to:
obtain image-based sound source location data from image analysis of one or more captured images;
encode multi-microphone audio as metadata assisted spatial audio comprising spatial audio metadata parameters; and
encode the image-based sound source location data within one or more spatial audio metadata parameters of the metadata assisted spatial audio, wherein the one or more spatial audio metadata parameters encoding the image-based sound source location data is or are the one or more spatial audio metadata parameters defining a spatial distribution of audio energy.

24. An apparatus as claimed in claim 23, wherein encoding the image-based sound source location data within the one or more spatial audio metadata parameters of the metadata assisted spatial audio comprises: varying the one or more spatial audio metadata parameters, that are a result of encoding the multi-microphone audio as the metadata assisted spatial audio, based on the image-based sound source location data.

25. An apparatus as claimed in claim 23, wherein the one or more spatial audio metadata parameters encoding the image-based sound source location data comprise at least one direction index dependent upon the image-based sound source location data.

26. An apparatus as claimed in claim 23, wherein the one or more spatial audio metadata parameters encoding the image-based sound source location data comprise at least one coherence parameter dependent upon the image-based sound source location data.

27. An apparatus as claimed in claim 23, wherein the one or more spatial audio metadata parameters encoding the image-based sound source location data comprise at least one spread coherence parameter dependent upon the image-based sound source location data, wherein the at least one spread coherence parameter defines coherence of a directional sound.

28. An apparatus as claimed in claim 27, wherein the at least one spread coherence parameter is varied in dependence upon the image-based sound source location data, to include the image-based sound source location data within an increased spatial distribution of audio energy defined by a varied spread coherence parameter.

29. An apparatus as claimed in claim 27, wherein the at least one spread coherence parameter is varied dependent upon a history of image-based sound source location data, to include a range of probable locations of the image-based sound source within the spatial distribution of audio energy defined by a varied spread coherence parameter.

30. An apparatus as claimed in claim 23, wherein the one or more spatial audio metadata parameters encoding the image-based sound source location data comprise at least one surround coherence parameter dependent upon the image-based sound source location data, wherein the surround coherence parameter defines coherence of non-directional sound.

31. An apparatus as claimed in claim 23, wherein the image-based sound source location data is indicative of one or more of: a width of a sound source, a size of the sound source or a direction of the sound source.

32. An apparatus as claimed in claim 23, wherein the image analysis comprises processing one or more captured images to generate the image-based sound source location data, wherein the image-based sound source location data defines at least a location for a sound source.

33. An apparatus as claimed in claim 23, wherein the image analysis comprises processing one or more captured images to generate the image-based sound source location data, wherein the image-based sound source location data defines at least a spatial distribution of a sound source.

34. An apparatus as claimed in claim 23, wherein the image analysis comprises processing one or more captured images to generate the image-based sound source location data, wherein the image-based sound source location data defines at least one of a shape or a size of a sound source.

35. An apparatus as claimed in claim 23, wherein the image analysis comprises processing one or more captured images to generate the image-based sound source location data for a sound source determined as a probable source of captured multi-microphone audio.

36. An apparatus as claimed in claim 23, wherein the image analysis comprises processing one or more captured images to generate the image-based sound source location data, wherein the processing of the one or more captured images is constrained to a direction of a probable source of captured multi-microphone audio.

37. An apparatus as claimed in claim 23, wherein the one or more captured images differ at least one by of time of capture or by field of view of capture.

38. An apparatus as claimed in claim 23, wherein the apparatus is further caused to convert the one or more captured images to time-frequency tiles for image analysis.

39. An apparatus as claimed in claim 23, wherein the apparatus is further caused to process the one or more captured images using a trained machine learning algorithm that uses synchronization of visual and audio modalities to jointly parse sounds and images, and associate parsed image regions with parsed sounds.

40. An apparatus as claimed in claim 23, wherein the apparatus comprises a body-portable apparatus.

41. A method comprising:
obtaining image-based sound source location data from image analysis of one or more captured images;
encoding multi-microphone audio as metadata assisted spatial audio comprising spatial audio metadata parameters; and
encoding the image-based sound source location data within one or more spatial audio metadata parameters of the metadata assisted spatial audio, wherein the one or more spatial audio metadata parameters encoding the image-based sound source location data is or are the one or more spatial audio metadata parameters defining a spatial distribution of audio energy.

42. A non-transitory computer readable medium comprising program instructions stored thereon for performing at least the following:
obtain image-based sound source location data from image analysis of one or more captured images;
encode multi-microphone audio as metadata assisted spatial audio comprising spatial audio metadata parameters; and
encode the image-based sound source location data within one or more spatial audio metadata parameters of the metadata assisted spatial audio, wherein the one or more spatial audio metadata parameters encoding the image-based sound source location data is or are the one or more spatial audio metadata parameters defining a spatial distribution of audio energy.
